(19) United States
(12) Patent Application Publication
(10) Pub. No.: US 2026/0171961 A1
(43) Pub. Date: Jun. 18, 2026

(54) SYSTEMS AND METHODS FOR DISPLAYING VIVID IMAGES ON SOLAR MATERIAL USING FILMS

(71) Applicants: Toyota Motor Engineering & Manufacturing North America, Inc., Plano, TX (US); Toyota Jidosha Kabushiki Kaisha, Toyota-shi Aichi-ken (JP)

(72) Inventors: Songtao Wu, Ann Arbor, MI (US); Debasish Banerjee, Ann Arbor, MI (US); Brian K. Woods, Brighton, MI (US); Ryota Tomizawa, Shizuoka-ken Susono-shi (JP); Shinya Iwasaki, Mizuho City (JP)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/985,330

(22) Filed: Dec. 18, 2024

(51) Int. Cl. H02S 40/20; G09F 13/16; H02S 20/23

(52) U.S. Cl. CPC H02S 40/20; G09F 13/16; H02S 20/23

(57) ABSTRACT

Embodiments described herein relate to a system that is shape adaptable having a lens film directing incident light toward solar material and display areas having components that improve image reflectivity and vividness. In one embodiment, the system includes a lens film that directs incident light within a first angular range for absorption and a second angular range toward viewing material, the viewing material within areas of the lens film and forms an image. The system may also include reflective components near the viewing material within the areas, the reflective components directing the incident light within the second angular range towards the viewing material. The system may also include absorption film bonded to the reflective components, the absorption film capturing energy from the incident light within the first angular range and the absorption film being hidden and the image being visible at the second angular range.

### TECHNICAL FIELD

The subject matter described herein relates, in general, to displaying an image on solar material, and, more particularly, to a system including a lens film that directs angles of incident light toward the solar material and display areas having components that improve image clarity.

### BACKGROUND

Solar panels harvest energy for systems powering devices and installations storing the energy for future usage such as power outages. These systems have solar panels with photovoltaic material installed in a metallic panel and encapsulated, such as with glass. The photovoltaic material releases electrons and generates an electric charge when exposed to photons from sunlight. The electric charge accumulates rapidly from limited photonic energy when having solar panels that are sizable. The electric charge can form current to power consumer electronics, home lighting, and small appliances. In one approach, the electric charge generates a direct current (DC) captured by wiring in solar panels for directly powering devices. The DC can also be converted to alternating current (AC) by an inverter for wall sockets in a building. The output power is directly correlated with the quantity of solar panels. As such, panel size and quantity impact the loads and device capacities the systems can power.

Moreover, in one embodiment, systems having a sizable array of solar panels for powering a neighborhood, commercial building, etc., may encounter difficulties due to poor appearances and aesthetics. For instance, neighborhood associations prohibit solar panels on roofs due to bulky hardware having unsightly designs. Local laws (e.g., zoning) can limit size and locations on buildings for solar installations. Localities can also demand a permit from an art commission in historic areas. Accordingly, systems having solar panels for powering demanding loads may generate insufficient energy from aesthetic qualities that limit installing sizable arrays.

### SUMMARY

In one embodiment, example systems relate to a device that is shape adaptable having a lens film directing incident light toward solar material and display areas having components that improve image reflectivity and vividness. In various implementations, systems using solar arrays for powering devices generate insufficient energy from poor aesthetics and rigidity (e.g., flatness) that constrain array sizes. Systems that alter the appearance of solar arrays can improve aesthetics and allow increased sizes. For instance, roofing material (e.g., tiles) for residential applications integrate solar arrays while maintaining desirable aesthetics. However, these systems may reduce harvesting efficiency for energy by overly obstructing sunlight. Also, displaying visuals on solar arrays can be blurred and lack definition, thereby reducing the aesthetic benefits. Additionally, roofing material integrated with solar arrays can exhibit rigid and inflexible properties that limit applications to flatter forms.

Therefore, in an example, a system uses a lens that is a film exhibiting flexible properties and the lens film selectively directs light for energy capture and otherwise towards an image for display. In one approach, the image includes reflective components that are directly printed onto the lens film for improving clarity and vividness through preventing unintended energy capture. An absorption film can be bonded to the reflective components for capturing energy from incident light within certain angles. The lens film may pass the incident light to viewing material forming the image and the reflective components at other angles, thereby hiding the absorption film while the viewing material is visible for beneficial aesthetics. The areas for the viewing material and energy capture can exhibit an alternating pattern. In this way, the system allows for improved aesthetic integration with high retention of energy harvesting.

In various implementations, a system includes ink material directly printed onto the lens film that captures energy from incident light. Here, the ink and the viewing materials may form a juxtaposed pattern. Furthermore, reflective components printed below the viewing materials reduce ghosting from inadvertent leakage of incident light to the ink, thereby improving definition. The lens film may direct incident light within an angular range for absorption by the ink and otherwise towards the viewing material for displaying an image. As such, the system forms a device for energy capture that is aesthetically pleasing without sacrificing energy harvesting that is efficient. Accordingly, the system displays an image at certain views without obstructing solar rays at other views that improves appearance for energy capture and expands applications through enhanced flexibility.

In one embodiment, a system that is shape adaptable having a lens film directing incident light toward solar material and display areas having components that improve image reflectivity and vividness is disclosed. The system may include a lens film that directs incident light within a first angular range for absorption and a second angular range toward viewing material, the viewing material within areas of the lens film and forms an image. The system may also include reflective components near the viewing material within the areas, the reflective components directing the incident light within the second angular range towards the viewing material. The system may also include absorption film bonded to the reflective components, the absorption film capturing energy from the incident light within the first angular range and the absorption film being hidden and the image being visible at the second angular range.

In another embodiment, a system that is shape adaptable having a lens film directing incident light toward solar material and display areas having components that improve image reflectivity and vividness is disclosed. The system may have a lens film that directs incident light within a first angular range for absorption and a second angular range toward viewing material, the viewing material within areas of the lens film and the viewing material forms an image. The system may also have reflective components near the viewing material within the areas, the reflective components directing the incident light within the second angular range towards the viewing material. The system may also have absorption components applied on the lens film capturing energy from the incident light within the first angular range, the absorption components being hidden at the second angular range and the absorption components located outside the areas.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A and 1B illustrate embodiments of a system exhibiting flexible properties including a lens film that controls angles of light towards a film material that absorbs energy and areas having viewing material and reflective components for displaying an image.

FIG. 2 illustrates an embodiment of a system having a lens film that controls angles of light towards a film layer that is flexible and absorbs energy and areas having viewing material and reflective components for displaying an image.

FIGS. 3A and 3B illustrate embodiments of a system having a lens film that controls angles of light towards an ink that absorbs energy and areas having viewing material and reflective components for displaying an image.

FIG. 4 is an embodiment of a system using a lens film, ethylene vinyl acetate (EVA) film, and solar film for energy capture and displaying an image.

### DETAILED DESCRIPTION

Systems, methods, and other embodiments include a device that is shape adaptable having a lens film that directs incident light toward solar material and display areas having components that improve image reflectivity and vividness. In various implementations, systems for energy capture can include films composed of amorphous silicon having some flexibility unlike panels using crystalline silicon that demand flat surfaces. Systems using certain film material can be more cost-efficient and lightweight than crystalline silicon systems. However, film materials can exhibit decreased efficiency and durability from bending compared to silicon panels. Films can have aesthetic qualities that are undesirable similar to silicon panels making usage and size limited. Therefore, systems using films for energy harvesting may encounter difficulties with efficiency, durability, and flexibility.

Therefore, in one example, a system includes a lens film that directs incident light within an angular range for absorption and another angular range toward viewing material. Here, the angular ranges can be viewing angles for the system such that at certain directions the incident light is transmitted to an absorption film for capturing energy. At other directions, the incident light travels to the viewing material having reflective components (e.g., white material) within areas of the lens film that forms an image (e.g., siding, an advertisement, etc.) improving system appearance. In one approach, the reflective components direct the incident light towards the viewing material for increasing clarity and vividness by blocking transmission to the absorption film. This prevents ghosting and interference caused darker colors of the absorption film. In this way, the system hides the absorption film from certain viewing angles and displays the image, thereby improving aesthetics and allowing expanded installations.

In one approach, the lens film has transparent material outside of the areas having the viewing material and the reflective components. This forms a flatter surface for the absorption film to readily attach with the transparent material and the reflective components. In another embodiment, the absorption film is one of copper indium gallium diselenide (CIGS) photovoltaic (PV) film and a perovskite-based film and the lens is a lenticular film that is highly transparent and fully flexible. In this way, the system allows installation areas that are overlarged and applications for curved structures through combined flexibility and improved aesthetics for capturing solar energy.

In another implementation, the system has the viewing material and the reflective components directly printed unto areas of the lens film. Furthermore, solar ink can be directly printed to transparent material near the viewing material outside of the areas forming a juxtaposed pattern that saves materials while absorbing energy and displaying an image. For example, the solar ink includes particles (e.g., flakes) made from absorption film and the particles form a pigment. As such, the lens film may pass incident light to the solar ink at certain angles while directing the light to the image at other angles, thereby hiding the solar ink and displaying an image. Accordingly, the system displays a clear and vivid image at certain angles using reflective components without obstructing solar rays at other angles that improves appearance for expanding applications, form factors, and installation designs through full flexibility.

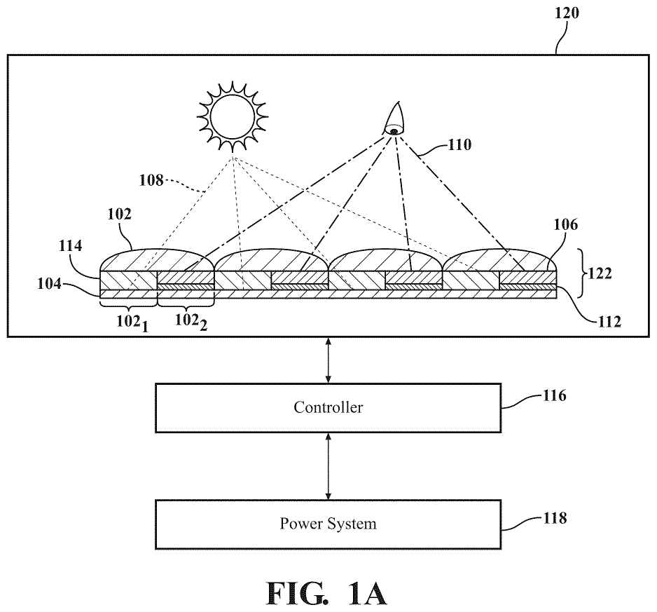

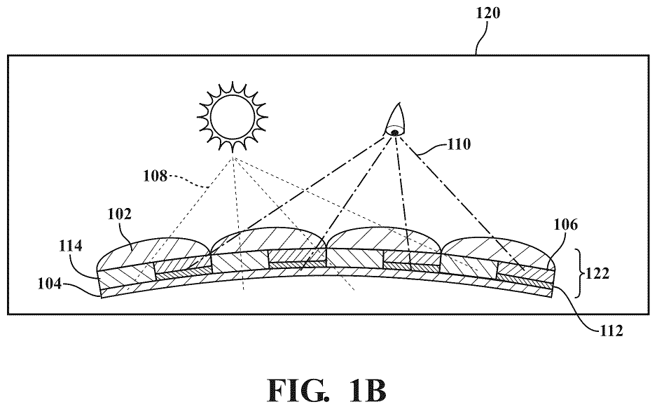

The systems are illustrated in FIGS. 1-4 also includes various elements. It will be understood that in various embodiments, the systems may have less than the elements shown in FIGS. 1-4. The systems can have any combination of the various elements shown in FIGS. 1-4. Furthermore, the systems can have additional elements to those shown in FIGS. 1-4. In some arrangements, the systems may be implemented without one or more of the elements shown in FIGS. 1-4. While the various elements are shown as being located within the systems in FIGS. 1-4, it will be understood that one or more of these elements can be located external to the systems. Furthermore, the elements shown may be physically separated by large distances.

Turning to FIGS. 1A and 1B, embodiments of a system exhibiting flexible properties including a lens film 102 that controls angles of light towards a film material 104 that absorbs energy and areas having viewing material 106 and reflective components 112 are illustrated. The system may be packaged in a device 120 that installs on a building façade, a vehicle, a billboard, etc. In the forthcoming examples, angular ranges, bands, etc., may be referenced as image bands that define angles at which the image (e.g., a black and white image, a color image, etc.) is viewable by a person, machine, etc. For example, the viewing material 106 mimics an object design, communicates a message, advertises information, etc. Accordingly, the system improves the aesthetics of the film material 104 by displaying images at certain viewing angles and at other angles directly guiding solar rays toward the film material 104 for energy harvesting.

In FIG. 1A, the device 120 includes the lens film 102 that directs incident light 108 within a first angular range for absorption and a second angular range toward the viewing material 106. In particular, the viewing material 106 and the second angular range can represent image bands within one of areas, sections, etc., of the lens film 102 and form an image. Here, the image can be one of a color, grayscale, black and white, etc., image. Furthermore, the reflective components 112 near the viewing material 106 within the areas of the lens film 102 can direct the incident light 110 within the second angular range towards the viewing material 106. In one approach, the film material 104 is an absorption film bonded to the reflective components 112. In this way, the absorption film captures energy from the incident light 108 within the first angular range while hidden at the second angular range from sight with the image being visible.

The lens film 102 may be a waveguide that optically controls and transmits incident light transparently toward the viewing material 106 and the film material 104. In one approach, the lens film 102 is a lenticular layer, a lenticular film, a lenticular lens, etc., composed of polyethylene terephthalate (PET) that is fully flexible, transparent, and forms a waveguide that efficiently and clearly directs incident light towards the viewing material 106 and the film material 104. In another approach, the lens film 102 is one of a polymer, acrylic, PET, polyethylene terephthalate glycol (PET-G), and polystyrene material. As such, the lenticular film and the absorption film can be thin films that adapt with a structural shape unlike crystalline silicon. Regarding controlling and directing incident light, the lens film 102 through customizable design has certain angular ranges (e.g., bands) of the incident light 108 directed through a transparent path to the film material 104. Although FIG. 1A references film material, any composition that absorbs solar or electromagnetic energy may be integrated with the lens film 102 for displaying an image while capturing energy.

In various implementations, the viewing material 106 and the reflective components 112 are applied to the lens film 102. For instance, these materials are applied by printing using a specialized printer that is high-resolution and precisely positions ink pigment, thereby improving image clarity by reducing ghosting and distortion. In particular, the reflective components 112 can reduce the incident light 108 being inadvertently absorbed or transmitted to the film material 104. Furthermore, the film material 104 can be a solar film that is CIGS PV film bonded to the reflective components 112 and transparent material 114 associated with the lens film 102. Here, bonding can involve using an adhesive that is clear. For instance, an optical adhesive that is clear enhances transparency and mitigates absorption losses for energy. In this approach, manufacturing the device 120 avoids alignment difficulties during bonding between the lens film 102 and the film material 104 since the viewing material 106 and the reflective components 112 are directly applied to the lens film 102 rather than another substrate initially. This also improves efficiency through avoiding an intermediate process.

The viewing material 106 can form pixels for the image using ink that is cured through thermal, light, and so on treatment. For example, the pixels form an image viewable within certain angular ranges and transparent otherwise. In other words, the pixels are reflective since the image is viewable within the certain angular ranges. Regarding materials, the viewing material 106 may be ink, organic ink, pigment, organic pigment, etc., having optimal properties for improving visibility and clarity from a distance.

Regarding further details about reflectivity, in another example, the reflective components 112 direct and control unreflected light when the viewing material 106 has transparent characteristics and insufficient opaqueness from brighter colors. Furthermore, the reflective components 112 can prevent image distortions by confining light within the areas. The incident light 110 can also reflect off the viewing material 106 without unintentional scattering, thereby providing increased reflectivity and image vividness. For instance, the reflective components 112 insulate the incident light 110 from the film material 104 exhibiting darkness (e.g., black, deep blue, etc.) causing optical interference. In other words, an image formed by the viewing material 106 can be distorted by light absorbed from a color of the film material 104 that otherwise would irradiate the image. Therefore, a material with increased reflectivity redirects more incident light and reduces absorption by the film material 104, thereby reducing image distortion, improving image quality, and increasing image resolution.

Moreover, horizontally, the reflective components 112 can occupy the space per area without extruding and bleeding into the lens film 102. As such, the device 120 increases harvesting efficiency and reduces blurred images through physical properties having horizontal precision. In another embodiment, the width of the reflective components 112 is congruent with the viewing material 106 through a controlled printing process that improves image contrast and sharpness.

Vertically, the reflective components 112 can occupy the space per area at a ratio with the viewing material 106 that improves thinness for the device 120. For instance, the device 120 exhibits deeper colors upon the ratio having the viewing material 106 equal to or greater than the reflective components 112. The ratio may also vary by each area for forming the image and exhibiting different visual effects. Similar to horizontal features, the device 120 may maintain precision and reduce costs by printing within a limited number of passes (e.g., two, four, etc.). This can continue until satisfying parameters for opaqueness between the viewing material 106 and the film material 104. For example, the parameter is that up to 99% of the incident light 110 reflects for irradiance rather than being absorbed by the film material 104. Accordingly, the device 120 improves reflectivity while avoiding ghosting from optical distortion and interference.

In various implementations, the lens film 102 is a lenticular waveguide that controls and directs the transmission of the incident lights 108 and 110. The lenticular waveguide can be an array of lenses that allows the visibility of the viewing material 106 at certain angles and generates optical effects. For example, the lenticular waveguide gives an image depth at certain colors and wavelengths. In one approach, the lens film 102 is a lenticular waveguide having pixels and the reflective components 112 directly printed onto the lenticular waveguide. This reduces thickness by forgoing a substrate for the viewing material 106 and the reflective components 112 and bonding to the lens film 102. This avoids alignment tasks between the lens film 102 and the film material 104 during production and manufacturing.

The device 120 can increase performance by reflecting the incident light to the viewing material 106 while retaining the majority of the incident light 108, thereby improving aesthetics and energy capture. For example, the system generates above 90% reflectivity within a certain angular range from including the reflective components 112 rather than 10% reflectivity. For energy harvesting, the device 120 can reach above 90% retention instead of 80% through other implementations. Therefore, the device 120 displays an image with the viewing material 106 that makes the film material 104 aesthetically pleasing and flexible that increases applications and available installation areas, thereby increasing energy capture.

Regarding details about applications, the device 120 can be integrated into a building for viewing an image while capturing solar energy. For example, the image displays one of an advertisement, an exterior façade, and roofing material. Here, solar rays at incident angles (e.g., 90-180 degrees) perpendicular to a building are transmitted toward the film material 104 by diffusing through the lens film 102. The film material 104 can be mounted at an angle, vertically, etc. For instance, the device 120 displays a gray, blue, etc., image that mimics a façade at incident light 110 (e.g., 0-90 degrees) from irradiation with reflected light. In other words, a pedestrian approaching the building sees an image, whereas the film material 104 directly absorbs solar energy at certain incident angles by unobstructed transmission through the transparent material 114. This improves aesthetics for the film material 104 while increasing power capture through expanding installation capabilities. Besides mimicking an object design, the image may also communicate a message, advertising information, etc. In this way, the system increases available installation areas of systems for energy capture by attractive designs within a community.

Additionally, the flexibility of the device 120 expands applications and installation capabilities on curved roofs, shaded canopies, building components, lightposts, vehicle panels, vehicle rooftops, etc. Here, an image formed by the viewing material 106 is viewable at certain angles while solar rays transmit toward the film material 104 at other angles. Accordingly, the system improves the aesthetics of the building and other surfaces without obstructing solar rays, thereby increasing efficiency and power capture.

FIG. 1B illustrates that the components 122 can have a curved form and flexibility. The film material 104 can be fully flexible and form a substrate for the lens film 102. For example, CIGS PV film can include solar cells that are fully flexible unlike silicon material (e.g., monocrystalline, polycrystalline, etc.) and exhibit efficient properties. Both the lens film 102 and the CIGS PV film being fully flexible allows applications on structures having increased curvature. For instance, the lens film 102 and the film material 104 (e.g., solar film) fully curve to form a complete circle, a circular shape (e.g., 270-360 degrees), a polygon, etc. Furthermore, the CIGS PV may have multi-layers that encapsulate solar cells for durability and water resistance while maintaining full flexibility. Thus, PV film allows efficient energy capture and coverage in expansive and disparate areas for powering demanding loads through increased capture areas.

Moreover, the film material 104 can be an absorption film composed of ethylene vinyl acetate (EVA) film that is transparent. In one approach, the EVA film is a CIGS PV film having layers that are individually encapsulated. This can increase the durability for the device 120 without effecting flexibility. Similar to other examples, the EVA film can be bonded to the reflective components 112 and transparent material 114 near the reflective components 112 using an adhesive.

In another approach, the transparent material 114 is one of adjacent, near, proximate, etc., to the viewing material 106 outside of certain areas associated with the lens film 102. In one way, the viewing material 106 and the reflective components 112 are juxtaposed, alternating, etc., with the transparent material 114. In various implementations, the transparent materials 114 and the first angular range represent a transparent band for transmission and energy capture associated with the incident light 108. For instance, the lens film 102 is composed of waveguide units shaped as one of a hemisphere, a demilune, a triangle, etc. The lens film 102 can be uniformly designed with various lens per inch in different areas through extrusion and rolling during manufacturing. The design can also have shapes to have various curvatures for adapting with different installations and application demands. The areas can be subunits 102₁ and 102₂. The subunits 102₁ can represent an area having parts of the transparent material 114. The subunits 102₂ have the viewing material 106 and the reflective components 112 applied to the areas, such using printing.

The widths of the viewing material 106 and the reflective components 112, the transparent material 114, the subunits 102₁ and 102₂ can vary depending upon demand for energy capture and visual quality. For instance, the viewing material 106 has a first width X and the transparent material 114 near the viewing material 106 has a second width Y. As an example, the first width X and the second width Y comprise one of a 1:1 ratio, a 2:1 ratio, a 3:1 ratio, and a 1:3 ratio. A person of ordinary skill in the art understands that systems herein can also implement any ratio. As such, the system can be designed where increasing X increases resolution while increasing Y increases energy capture.

The layering in FIG. 1A is an illustration. The transparent material 114 may be on a similar layer with the viewing material 106 and the reflective components 112. For instance, the viewing material 106 and the reflective components 112 has a minimum thickness when applied to the lens film 102 such that the viewing material 106 and the reflective components 112 form a consistent thickness and flat surface when bonding with the film material 104. Furthermore, in one approach, the reflective components 112 are a bright color (e.g., white) and improve clarity and vividness for the viewing material 106 by blocking the film material 104 from absorbing the incident light 110. Furthermore, the reflective components 112 increase reflectivity at the second angular range for displaying colorful images and giving an attractive appearance. Vividness is also improved by reducing ghosting through shielding the incident light 108 reflected off the film material 104.

Still referring to FIG. 1A, in one approach, a controller 116 can draw energy from the device 120 to power system 118 that stores energy captured by the film material 104. Similarly, a device, building, etc., can draw stored power from the power system 118. In various implementations, the controller 116 improves energy harvesting by adapting the orientation of the device 120 through different seasons using actuators. For example, an actuator tilts the device 120 ten degrees toward the equator during the wintertime for capturing additional light more directly. Accordingly, the controller 116 regulates power and enhances the capabilities of the device 120 through motion that improves energy harvesting.

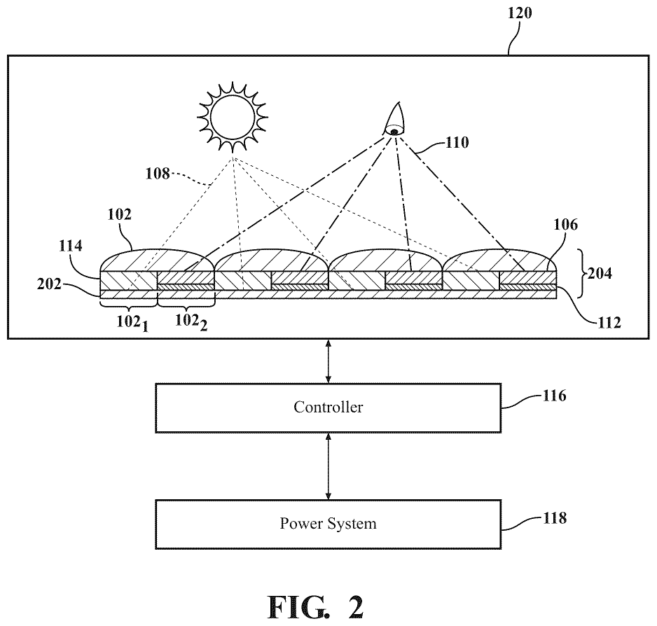

Turning to FIG. 2, an embodiment of a system having the lens film 102 that controls angles of light towards the film layer 202 that is flexible and absorbs energy and areas having viewing material 106 and reflective components 112 is illustrated. These components can form device 204 as part of the system. Certain components in FIG. 2 may operate similar to that described in FIG. 1A. In FIG. 2, the film layer 202 can be a perovskite-based film that is bonded to the lens film 102 and functions as a substrate that is flexible. The lens film 102 can have the viewing material 106 and the reflective components 112 applied to the lens film 102, such as through printing. Perovskite PV film is soft and flexible like CIGS PV film that can be bonded using a clear adhesive, such as an optical adhesive that is clear for enhancing transparency and mitigating energy absorption losses. In certain implementations, perovskite PV film can exhibit increased efficiency over CIGS PV film. Both the lens film 102 (e.g., a lenticular film) and the perovskite-based film layer 202 can be fully flexible. The fully flexible nature of PV film benefits applications for a vehicle hood, roofs, a bus stop, advertising, etc., and printing the viewing material 106 and reflective components 112 on the lens film 102 allows efficiency for energy harvesting and physical flexibility over other implementations (e.g., crystalline silicon).

In various implementations, the lens film 102 is a waveguide that directs the incident light 108 within a first band for absorption by the film layer 202 and a second band toward the viewing material 106. The viewing material 106 is within subunits 102₂ of the lens film 102 and the viewing material 106 forms an image. The reflective components 112 can be reflective material next to the viewing material 106 within the subunits 102₂ of the lens film 102. For instance, the reflective material directs the incident light 110 within the second angular range towards the viewing material 106. Furthermore, the film layer 202 can be absorption film bonded to the reflective material and the absorption film captures energy from the incident light 108 within the first band. This allows the absorption film to be hidden at the second band while the image is visible.

The device 120 can be originally manufactured and packaged as a product. The device 120 can also be formed as an aftermarket system. For instance, the film material 104 is solar film (e.g., CIGS PV film, perovskite PV film, etc.) and located on an existing structure. The solar film is bonded to the transparent material 114 and the reflective components 112 using an adhesive. This allows expanded applications for the device 120. This approach also avoids alignment difficulties between the lens film 102 and the film material 104 since the viewing material 106 and the reflective components 112 are applied to the lens film 102 rather than another substrate initially. Thus, the system simplifies production and assembly by directly applying the viewing material 106 and the reflective components 112 to the lens film 102.

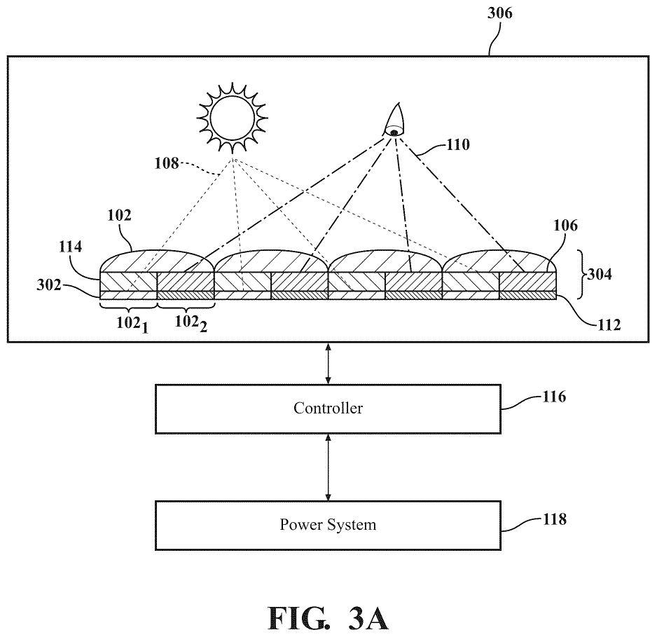

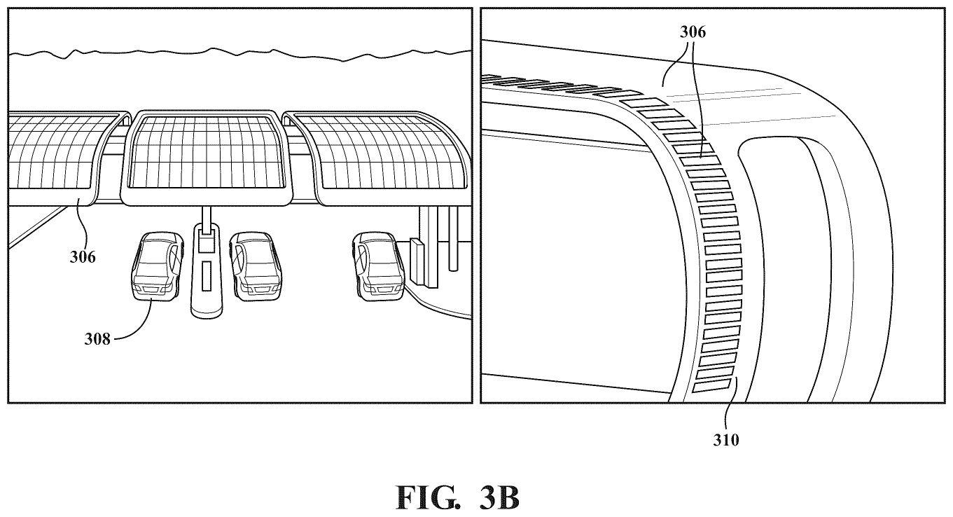

Now turning to FIGS. 3A and 3B, a device 306 has the lens film 102 that controls angles of light towards an ink that absorbs energy and areas having the viewing material 106 and the reflective components 112 are illustrated. Certain components in FIG. 3A may operate similar to that described in FIG. 1A. Here, the areas are the subunits 102₁ and 102₂ associated with the lens film 102. The device 306 includes the lens film 102 that directs the incident light 108 within a first angular range for absorption and the incident light 110 at a second angular range toward the viewing material 106. The viewing material 106 may be within the subunits 102₂ and form an image viewable at the second angular range. Furthermore, the reflective components 112 near the viewing material 106 within the subunits 102₂ direct the incident light 110 within the second angular range towards the viewing material 106.

Absorption components 302 applied on the lens film 102 capture energy from the incident light 108 within the first angular range. Otherwise, the absorption components 302 are hidden from sight and the viewing material 106 is visible by a viewer (e.g., a pedestrian). Here, the absorption components 302 can be hidden at the second angular range and located outside the subunits 102₂ within the subunits 102₁. The device 306 having the absorption components 302 limited to the the subunit 102₂ rather than the length of the lens film 102 saves and reduces material costs. For instance, the absorption components 302 are ink applied, printed, etc., to half a bottom, side, etc., surface of the lens film 102. In another embodiment, the widths of the viewing material 106 and the reflective components 112, the transparent material 114, the absorption components 302, and the subunits 102₁ and 102₂ vary depending upon demand for energy capture and visual quality. For example, the viewing material 106 has a first width X and the transparent material 114 and solar ink forming the absorption components 302 has a second width Y. As an example, the first width X and the second width Y comprise one of a 1:1 ratio, a 2:1 ratio, a 3:1 ratio, and a 1:3 ratio. A person of ordinary skill in the art understands that systems herein can also implement any ratio. As such, the system can be designed and adaptable where increasing X increases information content while increasing Y increases energy capture.

In one approach, the absorption components 302 are ink that form solar cells when assembled in an array. For instance, the ink is perovskite-based that may be ultraviolet curable upon application to the lens film 102 and fully flexible. This allows increased compatibility of the ink with various application approaches and avoids demands for a substrate. As such, a printer can apply the absorption components 302 to the lens film 102 directly without a substrate. Printing also increases the flexibility of the device 306, thereby improving applications.

In various implementations, the device 306 has layers exhibiting various configurations. For instance, the lens film 102 is a first layer, the transparent material 114 and the viewing material 106 form a second layer, and the reflective components 112 and the absorption components 302 form a third layer. Here, the third layer can be printed onto the second layer with the reflective components 112 aligned with the absorption components 302. This configuration can reduce costs through utilizing regular printers and avoiding secondary manufacturing tasks. In another configuration, the transparent material 114 and the viewing material 106 and the reflective components 112 coexist and align within a layer. Similarly, the transparent material 114, the viewing material 106, the reflective components 112, and the absorption components 302 may all be applied within a layer using the same machine. These configurations can exhibit thinness through purpose-built printers that apply fine material and pigments. In this way, the device 306 has configurations that meet various application requirements and parameters.

An embodiment of the device 306 includes the transparent material 114 being adjacent to the viewing material 106 outside of the areas represented by the subunits 102₂. Here, the absorption components 302 are solar ink directly printed to the transparent material 114. For instance, the solar ink comprises flakes made from absorption film and the solar ink and the viewing material form an alternating, juxtaposed, etc., pattern. Like other embodiments, the viewing material 106 and the reflective components 112 can be directly printed to the lens film 102, thereby increasing form flexibility through utilizing inks and film materials.

The device 306 may include the lens film 102 being a lenticular film (e.g., a polymer, acrylic, PET, PET-G, etc.) forming a waveguide that is durable and moisture resistant. Here, the lenticular film, the viewing material 106, and the absorption components 302 can be a device 304 that adapts to a structural shape. For example, the lenticular film is transparent and fully flexible. In this way, the device 306 allows for installations demanding adaptive form factors.

FIG. 3B illustrates an application of the device 306 as a canopy, station, etc., for the vehicle 308. The bus stop 310 having the device 306 is another application. Here, the device 306 has the lens film 102 that controls angles of light towards an ink that absorbs energy and areas having the viewing material 106 and the reflective components 112 are illustrated. The device 306 includes the lens film 102 that directs the incident light 108 within a first angular range for absorption and the incident light 110 at a second angular range toward the viewing material 106. For instance, the viewing material 106 may be within the subunits 102₂ and form an image viewable at the second angular range.

Moreover, the image can include a white appearance above the vehicle 308 near the front area that is viewable by passersby. Similarly, the image can replicate the siding of the enclosure for the bus stop 310. Meanwhile, the absorption components 302 capture solar energy at the first angular range near the top of the bus stop 310. Furthermore, the reflective components 112 near the viewing material 106 within the subunits 102₂ direct the incident light 110 within the second angular range towards the viewing material 106.

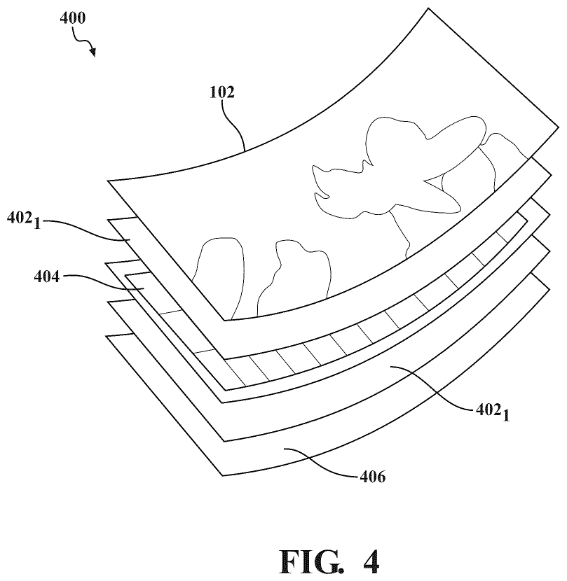

Concerning FIG. 4, an embodiment of a system 400 using a lens film 102, EVA film, and solar film for energy capture and displaying an image (e.g., a colorful image, a grayscale image, etc.) is illustrated. EVA can exhibit polymer affinity for bonding with PET-based devices and the lens film 102 that simplifies integration with other materials and systems. Here, the lens film 102 can have reflective material, transparent material, and viewing material applied and arranged similar to the device 120. In one approach, absorption film 404 is an EVA film exhibiting transparent and thin properties. For example, the EVA film is one of CIGS PV film and a perovskite-based film. Here, the absorption film 404 has layers that are individually encapsulated by material 402₁. For instance, material 402₁ is PET, PET-G, etc., film that is thin and flexible. The EVA film can be bonded to the reflective material and the transparent material near the reflective material using an optical adhesive that is clear. Furthermore, the material 406 can be a substrate or layer that improves bonding of the system 400 with a new installation, existing installation, etc.

The system 400 similar to the device 120 can be originally manufactured and packaged as a product. In another approach, the system 400 is formed as an aftermarket system. For instance, the absorption film 404 is based-EVA solar film located on an existing structure. The solar film is attached, bonded, etc., to the lens film 102 using an adhesive. This approach avoids alignment difficulties between the lens film 102 and the absorption film 404 since the viewing material and the reflective material are applied to the lens film 102 rather than another substrate initially. Accordingly, the system 400 displays a clear and vivid image at certain angles using reflective materials without obstructing solar rays at other angles that improves appearance for expanding applications, form factors, and installation designs for energy harvesting through full flexibility.

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

1. A system comprising:
a lens film that directs incident light within a first angular range for absorption and a second angular range toward viewing material, the viewing material within areas of the lens film and forms an image;
reflective components below the viewing material within the areas, the reflective components directing the incident light within the second angular range towards the viewing material and the reflective components are different than the lens film and a white material; and
absorption film bonded to the reflective components and located below the reflective components, the absorption film capturing energy from the incident light within the first angular range and the absorption film being hidden and the image being visible at the second angular range.

2. The system of claim 1, wherein:
the viewing material and the reflective components are directly printed to the lens film using a juxtaposed pattern with transparent material between the viewing material and the reflective components;
the absorption film is a solar film that is one of copper indium gallium diselenide (CIGS) photovoltaic (PV) film and a perovskite-based film; and
the solar film is flexible forming a substrate for the lens film.

3. The system of claim 2 further comprising:
the transparent material adjacent to the viewing material outside of the areas; and
the reflective components and the viewing material are directly printed without an intermediate material;
wherein the solar film is bonded to the transparent material and the reflective components using an adhesive.

4. The system of claim 2, wherein:
the lens film and the solar film are configured to curve and form a complete circle; and
the image displays one of an advertisement, an exterior façade, and roofing material.

5. The system of claim 2, wherein the solar film is located on an existing structure and the solar film is bonded to transparent material and the reflective components on the lens film using an adhesive.

6. The system of claim 2, wherein:
the viewing material has a first width and the transparent material near the viewing material has a second width; and
the first width and the second width comprising one of a 1:1 ratio, a 2:1 ratio, a 3:1 ratio, and a 1:3 ratio.

7. The system of claim 1, wherein:
the absorption film is composed with ethylene vinyl acetate (EVA) film;
the EVA film is associated with one of copper indium gallium diselenide (CIGS) photovoltaic (PV) film and a perovskite-based film;
the EVA film has layers that are encapsulated; and
the EVA film is bonded to the reflective components and transparent material near the reflective components using an adhesive.

8. The system of claim 1, wherein:
the lens film is a lenticular film composed with one of a polymer and polyethylene terephthalate (PET) that forms a waveguide;
the lenticular film and the absorption film adapt to a structural shape having a curvature; and
the lenticular film is transparent and flexible.

9. A system comprising:
a lens film that directs incident light within a first angular range for absorption and a second angular range toward viewing material, the viewing material within areas of the lens film and the viewing material forms an image;
reflective components below the viewing material within the areas, the reflective components directing the incident light within the second angular range towards the viewing material and the reflective components are different than the lens film and a white material; and
absorption components applied on the lens film and located below the reflective components capturing energy from the incident light within the first angular range, the absorption components being hidden at the second angular range and the absorption components located outside the areas.

10. The system of claim 9 further comprising:
the absorption components are solar ink directly printed to transparent material, wherein the solar ink comprises particles made from absorption film and the solar ink and the viewing material form a juxtaposed pattern;
wherein the viewing material and the reflective components are directly printed to the lens film using the juxtaposed pattern with the transparent material directly between the viewing material and the reflective components.

11. The system of claim 10, wherein:
the viewing material has a first width and the solar ink has a second width; and
the first width and the second width comprising one of a 1:1 ratio, a 2:1 ratio, a 3:1 ratio, and a 1:3 ratio.

12. The system of claim 9, wherein:
the lens film is a lenticular film composed with one of a polymer and polyethylene terephthalate (PET) that forms a waveguide;
the lenticular film, the viewing material, and the absorption components adapt to a structural shape having a curvature; and
the lenticular film is transparent and flexible.

13. A system comprising:
a lens film that is a waveguide and directs incident light within a first angular range for absorption and a second angular range toward viewing material, the viewing material within areas of the lens film and the viewing material forms an image;
reflective material directly below the viewing material within the areas, the reflective material directing the incident light within the second angular range towards the viewing material and the reflective material is different than the lens film and a white material; and
absorption film bonded to the reflective material and located below the reflective material, the absorption film capturing energy from the incident light within the first angular range and the absorption film being hidden and the image being visible at the second angular range.

14. The system of claim 13, wherein:
the viewing material and the reflective material are directly printed to the lens film using a juxtaposed pattern with transparent material directly between the viewing material and the reflective material;
the absorption film is a solar film that is one of copper indium gallium diselenide (CIGS) photovoltaic (PV) film and a perovskite-based film; and
the solar film is flexible forming a substrate for the lens film.

15. The system of claim 14, wherein:
the transparent material is adjacent to the viewing material outside of the areas, and the transparent material is part of the lens film; and
the reflective material and the viewing material are directly printed without an intermediate material;
wherein the solar film is bonded to the transparent material and the reflective material using an optical adhesive that is clear.

16. The system of claim 14, wherein:
the lens film and the solar film are configured to curve and form a circle; and
the image displays one of an advertisement, an exterior façade, and roofing material.

17. The system of claim 14, wherein the solar film is located on an existing structure and the solar film is bonded to transparent material on the lens film and the reflective material using an optical adhesive that is clear.

18. The system of claim 14, wherein:
the viewing material has a first width and the transparent material near the viewing material has a second width; and
the first width and the second width comprising one of a 1:1 ratio, a 2:1 ratio, a 3:1 ratio, and a 1:3 ratio.

19. The system of claim 13, wherein:
the absorption film is composed with ethylene vinyl acetate (EVA) film;
the EVA film is associated with one of a copper indium gallium diselenide (CIGS) photovoltaic (PV) film and a perovskite-based film;
the EVA film has layers that are encapsulated; and
the EVA film is bonded to the reflective material and transparent material near the reflective material using an optical adhesive that is clear.

20. The system of claim 13, wherein:
the lens film is a lenticular film composed with one of a polymer and polyethylene terephthalate (PET) that forms a waveguide;
the lenticular film and the absorption film adapt to a structural shape having a curvature; and
the lenticular film is transparent and flexible.
